(19) United States
(12) Patent Application Publication
(10) Pub. No.: US 2019/0080282 A1
(43) Pub. Date: Mar. 14, 2019

(54) MOBILE INSPECTION AND REPORTING SYSTEM

(71) Applicant: Viatap, Inc., Lafayette, CA (US)

(72) Inventors: Darren Beyer, Lafayette, CA (US); Jeremy Bjorem, Kansas City, MO (US)

(73) Assignee: Viatap, Inc., Lafayette, CA (US)

(21) Appl. No.: 16/128,970

(22) Filed: Sep. 12, 2018

Related U.S. Application Data
(60) Provisional application No. 62/558,258, filed on Sep. 13, 2017.

(51) Int. Cl. G06Q 10/08; H04W 4/35; G06K 9/00

(52) U.S. Cl. CPC G06Q 10/087; G06Q 20/203; G06K 9/00664; H04W 4/35

(57) ABSTRACT

A reporting method including receiving, at a server, target authority information, said target authority information including identifying information and contact information related to a target. Also receiving at the server, a media information, such as a picture or audio recording that includes location information generally identifying the location the media represents. The server may then analyze the media information to identify target information. The analysis may identify the object or the absence of an object or other characteristics including but not limited to inventory. Operations further compare the target information to the target authority information, and transmit target information to the target authority using the contact information.

### PRIORITY

This application claims the benefit of co-pending provisional patent application 62/558,258 filed Sep. 13, 2017 by the same inventor which is included by reference as if fully set forth herein.

### BACKGROUND

One problem in any industry with multiple distribute product sales or delivery channels is the ability to manage those sales points remotely. For example, and without limitation, a retailer may have many different points of sales, sometime located within other retail outlets. Or a property management company may manage many different properties from a remote location.

Conventionally employees will gather information for reports using a notepad, a handheld GPS, and a handheld camera, during an inspection. if needed. These workers may go from site to site collecting the information needed for the particular reporting they do. Sometimes a problem will not be noticed until an employee arrives to re-stock shelves or to clean a facility. Even then, if data is collected by the field worker, that field worker must someone identify the responsible person to report a problem to. These reports then need to be delivered to interested parties; therefore, the data must be maintained by the reporting company.

Each step of the process—collecting, organizing, maintaining and updating inspection data—is tedious, time-consuming, and error-prone. Furthermore, there is no way to guarantee that the inspection was actually performed on-site (i.e., at a location that was part of the site inspection). Due to the significant opportunities for error and/or outright fraud in the current methods for collecting and processing inspection data, companies are at risk for loss in those problem areas.

### SUMMARY

Disclosed herein is a reporting method which includes receiving, at a server, target authority information, said target authority information including identifying information and contact information related to a target, receiving, at the server, a media information, said media information including location information, analyzing the media information to identify target information, comparing the target information to the target authority information, and transmitting target information to the target authority using the contact information. Certain embodiments may employ all or only elements of this method to effectuate the disclosure. In addition, this disclosure provides for many system elements such as human input devices, sensor stations, beacons, and the like, to effect certain embodiments.

Certain embodiments may be effectuated using the information in the attached Technical Appendix which, together with its associated figure, is incorporated by reference as if fully set forth herein.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 describes an overview of a system which may be effectuated in certain embodiments.

FIG. 2 describes a method flow for collecting remote information.

FIG. 3 illustrates a method for processing reportable information.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The term “App” or “Application” generally means a set of program instruction running or operable to run on a processor device.

The term “Beacon” generally refers to a class of Bluetooth low energy (LE) devices that broadcast their identifier to nearby portable electronic devices. The unique identifier may be picked up by a compatible app or operating system. The identifier and several bytes sent with it can be used to determine the device's physical location track customers, or trigger a location-based action on the device such as a check-in on social media or a push notification.

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “Near field communication” (NFC) is generally a set of communication protocols that enable two electronic devices, one of which is usually a portable device such as a smartphone, to establish communication by bringing them within close proximity of each other. NFC protocols established a generally-supported standard. NFC-enabled portable devices can be provided with apps, for example to read electronic tags or make payments when connected to an NFC-compliant apparatus.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity and does not in itself dictate a relationship between the various embodiments and/or configurations discussed. Moreover, the systems elements described herein may not all be used in each embodiment, or may be used in part in some embodiments.

### System Elements

### Human Input Device

Conventionally, a human interface device (HID) is a type of computer device that interacts directly with, and most often takes input from, humans and may deliver output to humans. The term “HID” most commonly refers to the USB-HID specification. HID-defined devices conventionally deliver self-describing packages that may contain any number of data types and formats. In the HID protocol, there are 2 entities: the “host” and the “device”. The device is the entity that directly interacts with a human, such as a keyboard or mouse. The host communicates with the device and receives input data from the device on actions performed by the human. Output data flows from the host to the device and then to the human. The most common example of a host is a PC but some cell phones and PDAs also can be hosts.

The HID protocol makes implementation of devices very simple. Devices define their data packets and then present a “HID descriptor” to the host. The HID descriptor may be a hard-coded array of bytes that describe the device's data packets. This may include: how many packets the device supports, the size of the packets, and the purpose of each byte and bit in the packet. For example and without limitation, a keyboard with a calculator program button can tell the host that the button's pressed/released state is stored as the 2nd bit in the 6th byte in data packet number 4 (note: these locations are only illustrative and are device-specific). The device typically stores the HID descriptor in ROM and does not need to intrinsically understand or parse the HID descriptor.

Conventionally, the host is a more complex entity than the device handling the bulk of the processing transactions. The host needs to retrieve the HID descriptor from the device and parse it before to fully communicate with the device.

In certain embodiments described herein, an HID may be emulated by a device which is not directly coupled to a human. For example, in certain embodiments a user may interact with a remote device such as a smartphone or tablet. The remote device may then emulate the HID such that it appears as an HID to other devices. In some embodiments a sensor station may be employed that interacts with the remote device and appears as an HID to a connected device or a network. Conventionally, emulation may be performed through “spoofing” which generally means masquerading as another device. As a representative example only, a sensor station may spoof being a bar-code scanner attached to a cash register while simultaneously acting as a Bluetooth enabled device coupled to a smartphone. The user, by manipulating an application on a smartphone, may then provide payment information to the cash register, while the cash register acts as if it is receiving information from a bar-code scanner.

### Sensor Station

Certain embodiments may employ a sensor station to effect features of the present disclosure. For example and without limitation, a sensor station might be a processor controlled device with memory for storing processor instructions and data. The sensor station may employ one of several engagement mechanisms including one or more of the following:
Ethernet for network connectivity
WiFi for Internet connectivity
USB for local connectivity
Bluetooth for wireless connectivity
NFC
A/D convertor(s)
Accelerometer(s)
Position sensors for heading, pitch, & roll
rotation matrix quaternions
Raw sensor data

In operation, processor code may operate the hardware features to effect an HID using Bluetooth or a USB port while simultaneously communicating with a mobile device through other connectivity features. Position sensors and accelerometers may allow for the processor to operate certain instructions in response to movements and changes in location.

Emulating an HID device may be effectuate in several ways including, but not limited to, emulating a card reader through one of the ports, emulating a keyboard through a port, or emulating commercial payment systems such as Apply Pay, Square and other mobile point-of-sale systems.

### Beacon

The sensor station may also programmatically effect a beacon function which would trigger operations between a mobile device and the sensor station, thus reducing or eliminating the need for a user to manually run an application on their mobile device such as a smartphone. In some embodiments, when a user approaches a sensor station, an application running on a mobile device would detect the presence of the beacon and connect to the sensor station. Validation may be performed using a unique ID and a token.

Embodiments in the present disclosure may relate to utilizing one or more of the following components, however, no requirement that all of the system elements be used or that they be used in any particular combination.
Merchant point of sale system or computing device
Customer mobile (wireless) device and associated application
A Wifi access point
Sensor station
Physical remote device (PRD)
A host system
A third party payment or loyalty processor

### Media Analysis

Certain embodiments according to the current disclosure may employ various forms of object recognition to identify an object of interest (a target) in an image. Object recognition may be effectuated from rasterized or vector shapes. Rasterized or vector shapes may be created from an image by having a user select all (or a portion) of a particular shape and rendering the shape into as the desired format. Structural analysis and shape descriptors may be calculated from routines to determine the moments of an image and the mass center of an image.

Once structural analysis and moments are computed, a data source containing information about the structure of an object may be queried to identify an object in a video or still image by calculating the object's structure and searching a data store for like objects. In other embodiments edge orientation histograms may be employed. A histogram of oriented gradient descriptors describes a shape within an image by the distribution of intensity gradients or edge directions. In other embodiments software may be employed to characterize the object of the video or image. For example and without limitation, once an image of the object is captured, relative geometry values may be calculated as well as indications of color, and texture. Conventionally color histograms, color tuples and filtering are employed to characterize and image. This data may be calculated and stored as meta-data along with the image.

In some embodiments items in a video or image may be identified using a boundary box. The boundary box may be identified at an early or first frame of a video by selecting one or more edges of the image of the desired item. The boundary box process may use edge detection or feature point detection to identify all visible edges or features of the item. Once identified, similar detection may be applied to each subsequent frame of a video. If the object or a feature point are detected in the first frame or its subsequent frame tracking an object edge or feature point for each subsequent frame may be effected using conventional algorithms. A calculation engine may be used to perform transformations of each object edge or feature point detected in the first frame or subsequent frames to calculate edges or features as the camera angle for the desired object changes.

In some embodiments a user may capture an image using a camera on a mobile device, perform object recognition on a portion of the image. The object recognition may be performed at the camera level or image information may be transmitted to a server for recognition. Commercial image recognition tools such as image recognitions APIs, may be employed by a remote device or coupled to a server, to identify a target in an image. Similar to image analysis, audio may also be identified using conventional audio identification techniques.

### Elevation

GPS is a powerful tool used in filed operations because of its ability to accurately detect location. The ability of GPS to provide accurate horizontal positioning is well-documented, however, there is considerable debate regarding the accuracy of elevation information derived from GPS observations because GPS elevations are generally less accurate than the horizontal positions gained from GPS. Even so, there is a tremendous value to the elevations provided by precise, carrier-phase GPS observations. These elevations have many uses in the methods in the present disclosure. A GPS receiver may use a model to calculate the elevation which requires a correction before it is truly your elevation above sea level. Conventionally, this elevation may be determined by using the simple GPS coordinates and a known value called the ‘reference ellipsoid’ to determine height about sea level, to varying degrees of accuracy.

In some embodiment elevation may be associated with or programmed into a sensor station as described herein. The sensor station may have a known location with a unique Id number to allow querying a structure data source for position information, or the beacon may determine its own elevation in response to a GPS signal.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Overview

The present disclosure presents a computer-implemented system and method for collecting data in the field and reporting the results, and other features. Some embodiments may use a portable remote device such as a smart phone or a tablet computer, and the like, that may include a camera, GPS, Bluetooth, NFC or other means of network communication. The present application is platform-independent and may be installed on many devices usable in the field.

The client application that is installed on the portable device or tablet computer presents the user with a simple interface. In operation, the user (or field worker) may photograph the item of interest (the target) and transmit the information to a network. In some embodiments, the user may also electronically couple the remote device to a sensor station to verify location information, and optionally enter identifying information of the target, or status information regarding the target. The target image and any associated information comprise a record.

Once a record is transmitted to a network, a server process may identify the target and target location. Conventional image analysis tools may be used in certain embodiments. From this information, the server may access a predetermined list of responsible authorities and transmit to them the information from the user. Accordingly, the predetermined list may include one or more of the following:

Target name

Target Supplier

Target condition

Product information

Primary authority contact information

Location information

In certain embodiments, if wireless Internet access is available, then the target image and associated information may be submitted to the server, and any rules-based notifications are sent, in real time. The rules-based notifications may include sending copies of a report to certain individuals. The server may processes each record it receives by checking the record against client-based rules to determine whether and which notifications need to be sent and saving the record to the database. If wireless Internet access is not available, then the record may be saved locally (i.e., on the remote device itself) until such time that wireless Internet access is available.

If notifications are required based on client business rules, then a text or email message will be sent to the appropriate authorities. The client business rules may be based on any criteria set by the client; by way of example only, the client business rules may require that a notification be sent only after a certain number of records have been received reporting the same or similar condition from a single location.

In certain embodiments, the application that is installed on the remote device will automatically gather a GPS coordinate and attach it to the record as numeric data (e.g., longitude and latitude coordinates), altitude information may also be included. This feature may allow for a higher level of auditability and reduced risk by proving that records were generated and corrective actions taken within a certain time frame and at a certain location. Other embodiments may include a symbolic scanner or bar code reader on a mobile device, which may scan or otherwise image a bar code o other unique indicia to verify the mobile device is in a predetermined location.

Object Recognition

Certain embodiments may employ various forms of object recognition and tracking. Object recognition may be effectuated from rasterized or vector shapes. Rasterized or vector shapes may be created from an image by selecting all (or a portion) of a particular shape and rendering the shape into as the desired format. Structural analysis and shape descriptors may be calculated from routines to determine the moments of an image and the mass center of an image.

Once structural analysis and moments are computed, an image may be identified in an object by tracking the movement of a key point or by identifying structure and moments and comparing the data to pre-existing data. Accordingly, a data source containing information about the structure of an object may be queried to identify an object in a video or still image by calculating the object's structure and searching a data store for like objects. In other embodiments edge orientation histograms may be employed. A histogram of oriented gradient descriptors describes a shape within an image by the distribution of intensity gradients or edge directions. The implementation of these descriptors may be achieved by dividing the image into small connected regions, called cells, and for each cell compiling a histogram of gradient directions or edge orientations for the pixels within the cell. The combination of these histograms then represents the descriptor. In some embodiments, the local histograms can be contrast-normalized by calculating a measure of the intensity across a larger region of the image, called a block, and then using this value to normalize all cells within the block, in effect mitigating in part variances from changes in illumination or shadows. Background removal may be effectuated using conventional techniques such as chroma-key replacement or background subtraction.

In other embodiments, software methods may be employed to characterize the object, relative geometry values may be calculated as well as indications of color, and texture. Conventionally color histograms, color tuples and filtering are employed to characterize and image. This data may be calculated and stored as meta-data along with the image.

In some embodiments items in a video may be identified using a boundary box. The boundary box may be identified at an early or first frame of a video by selecting one or more edges of the image of the desired item. The boundary box process may use edge detection or feature point detection to identify all visible edges or features of the item. Once identified, similar detection may be applied to each subsequent frame of a video. If the object or a feature point are detected in the first frame or its subsequent frame tracking an object edge or feature point for each subsequent frame may be effected using conventional algorithms. A calculation engine may be used to perform transformations of each object edge or feature point detected in the first frame or subsequent frames to calculate edges or features as the camera angle for the desired object changes.

By way of illustration and without limitation, if a boundary box is created about an object in a first frame of video, as the frames of the video move, object detection will identify the trajectory of the object through the relative eye of the camera. Once identified, the object may be abstracted into a new video without the background images. Moreover, edge or feature detection may provide for identification of 3D objects as the trajectory of the edge of feature moves within the video frame. An edge or feature moving off camera may allow for detection of related edges or features entering the frame at the same or similar trajectory. If a full 360 degree video of an object is captured, the final frame will include the edge or feature of the initial frame allowing extraction from the video of the item's characteristics.

Object recognition and tracking allows for finding a particular object in an image or video. The view of the object may track the background image by presenting the object in 3 dimensions. Accordingly, certain embodiments may allow for creating a collection of objects which may be represented in 3 dimensions. These objects may be categorized and made searchable.

Once objects in a video are recognized, identification information, such as description may be presented to a user. Optional variations for the object may also be presented. For example, and without limitation, if a user selects or captures video of a bedroom, then selects a portion of the video showing a chair, image analysis can identify characteristics about that chair and search a database to find like or similar chairs. Then the user may be presented with reporting information, such as “needs replacement” or “needs cleaning” and the like.

In some embodiments, a user may capture an image using a camera on a mobile device, perform object recognition on a portion of the image. The object recognition may be performed at the camera level or image information may be transmitted to a server for recognition. The server may then present to the user a like or similar object which the user may then select. Once selected, an image or video of the like or similar object may be employed as part of a report. For example, and without limitation, if a user were to photograph a bedroom, then select a portion of a lamp in the bedroom, the server may, in response to that selecting, provide the user with options for the report.

### Machine Learning

Certain embodiments of this disclosure may employ machine learning to develop algorithms that can learn from and make predictions on data—such algorithms overcome following strictly static program instructions by making data-driven predictions or decisions, through building a model from sample inputs. Machine learning may employed in a range of computing tasks, including, but not limited to, email filtering, detection of a data breach, optical character recognition (OCR), learning to rank, and computer vision. Predictive analytics may be employed to analyze historical reporting data and estimate future reporting information. For example, seasonally adjustable retail product display damage may be estimated to allow for better preparation of retail space.

### Detailed Operation

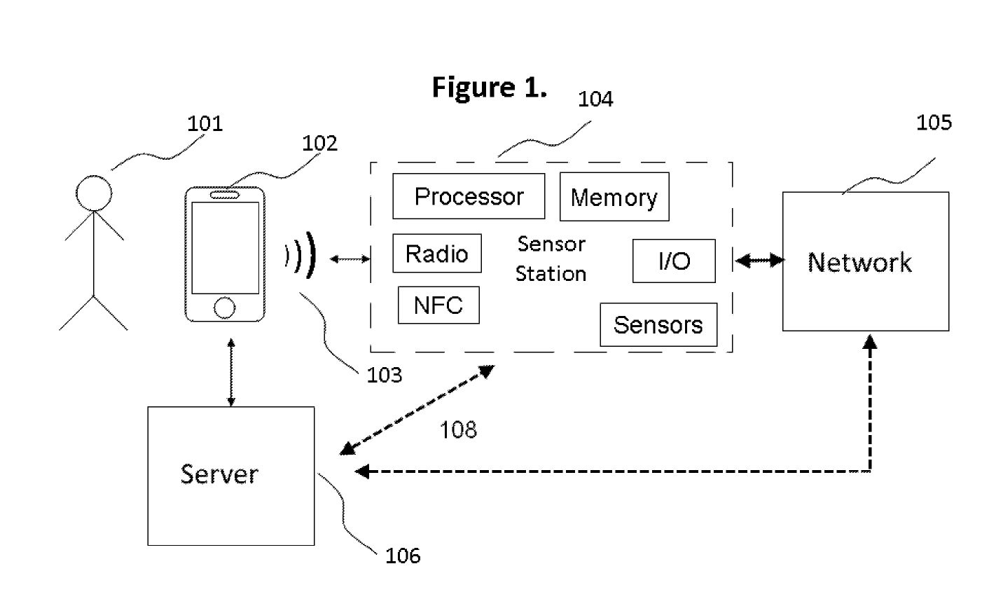

FIG. 1 describes an overview of a system which may be effectuated in certain embodiments. The user (or consumer) 101 presents a mobile device and associated application 102 to close proximity of the sensor station 104 which may transmit initiation signals via wireless protocol 103. The mobile device and associated application 102 respond via wireless protocol 103 to the sensor station 104. The sensor station 104 may respond to the mobile device utilizing security protocols to establish a link. The mobile device and application 102 may deliver a digital message to the sensor station 104 for the purpose of further sending to a network (or Internet) 105. The sensor station 104 may send an additional signal via wireless protocol 103 to the mobile device and associated application 102 to terminate the session.

The transaction may be facilitated through the use of information supplied by a server system 106. The mobile device 102, by coupling to the server 106, may provide images, audio, movies, and the like. The server may include (or be coupled to) an image database to allow for recognition or comparisons of images. Some embodiments may include a sensor station 104 that is also coupled to the server 106 through conventional means 108 such as WiFi, common carrier, Ethernet and the like. Coupling a sensor station 104 to a host system enhances security by allowing for location verification and token verification as well as allowing for upgrades to software. Some embodiments may virtualize the server 106 by having it as a cloud application coupled to the network 105.

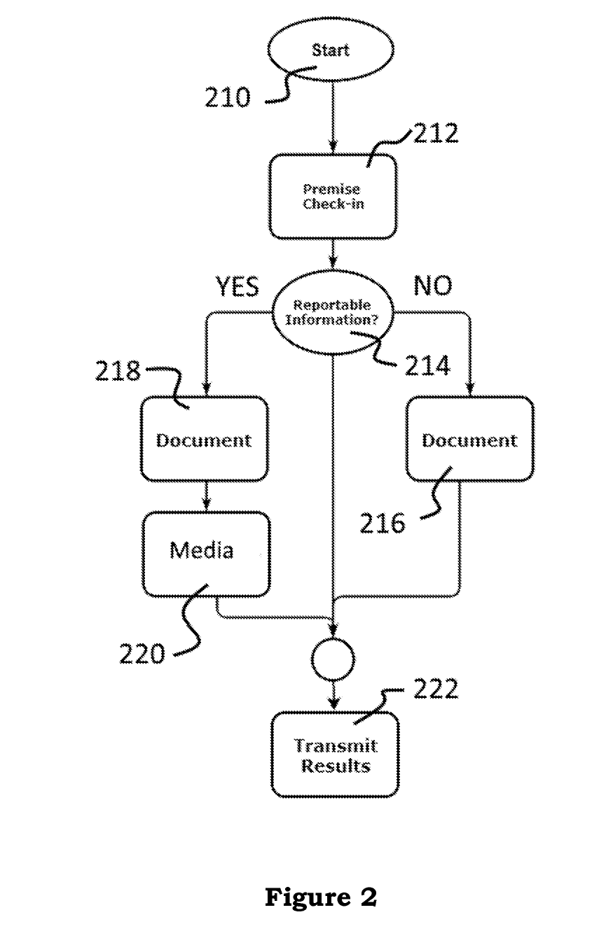

FIG. 2 describes a method flow for collecting remote information. The method begins at a flow label 210. At a step 212 a user checks in. Checking in may entail capturing the location of the inspection site, or electronically coupling to a sensor station as described herein. At a step 214, the user determines I there is reportable information at the location. Reportable information is information that the users of the process desire to know. This may include, but is not limited to, condition of a facility (or part of a facility), condition of a product display, stocking level of inventory, cleanliness of an environment, and other such generally associated field inspection information. If there is no reportable information, flow proceeds to a step 216 where a user may optionally acknowledge that they were present at the premises.

If there is reportable information, the method proceeds to a step 218, where documentation (if any is needed) is provided by the user. The documentation may include status updates, asking for specific information or simply selecting from selection controls what type of reportable information is being reported. Some examples may include inventory, cleanliness, broken display, etc. At a step 220 media is collected. The media may be a photograph, audio recording, motion image or other indicia of the reportable information. Results are transmitted at a step 222.

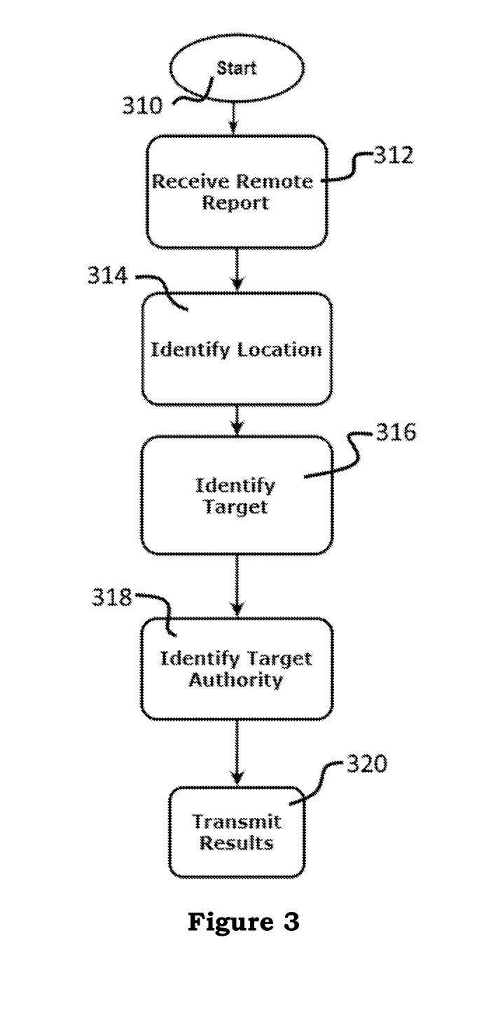

FIG. 3 illustrates a method for processing reportable information. The method begins at a flow label 310 and moves to a step 312. At the step 312 the remote report is received. At a step 314 the location information from the report is used to retrieve location information from a structured data source. The location information may be any data used to effectuate the results of the reporting including type of information requested, imagery of the location, historical data and other premised-based information.

At a step 316 the target is identified. The target may be all or a portion of the reported information. For example, and without limitation, an image of a display case or a restroom. At step 316 the target may also be identified using image analysis, audio analysis, or video analysis. In some embodiments, once the target is identified, a comparison between a “known good” media and the target may be made to ascertain what information is desired. For example, and without limitation, a target may be an empty store shelf, an empty gift card display, an aisle end unit, a package in transit, a restroom, gas pump, a vending machine, and the like. These targets may be compared with an image of a full display to illustrate that some product is mis-placed or missing and needs restocking. In some cases, a display may be compared to a display plan-o-gram image for determining the proper course of action. Other examples include images of restroom facilities showing broken fixture, machine sounds, broken store displays, unclean facilities and the like. Target identification may also be supplied, in some embodiments, from the remote report by having a user select or enter the information.

In yet other embodiments, estimations of possible problems or conditions may be determined using information about the location maintained in a structured data source. For example, and without limitation common problems identified at a particular location may be presumed in response to certain images. For example, and without limitation, comparing a known good image with a current image to determine a degree or measure of difference. In some embodiments, a user may be prompted to supply more information regarding the target, such as more images from different angles, or more audio.

At a step 318 a target authority is identified. For example, and without limitation, an image of a restroom might be analyzed and broken plumbing identified—the target is the plumbing and the target authority may be a local plumber. Similarly, the target might be an empty store display, and the target authority may be the local product distributor.

At a step 320 the results of the method are transmitted to the target authority. These results may include the media from the report, along with any determinations made in the processing. For example, and without limitation, a measure of the amount of differences between a known good image and a reported image. Other examples may include an estimate of the reportable information (low product, unclean facilities, damaged display case, and the like), to determine if they meet a minimal threshold of change. If no determinations are made, then the media may be sent to the target authority for a determination of any actions that might be needed.

### Mobile Devices

The mobile devices may conduct contact with the sensor station in several ways. In some embodiments it may initiate communication through a built-in accelerometer in the mobile device, wherein certain movements (such as tapping or shaking) start the process. In some embodiments it may initiate communication via user interaction in a mobile application. In some embodiments it may initiate communication via proximity to the sensor station, determined by analyzing the signal supplied by the sensor station such as a beacon. Any of these actions may trigger Bluetooth Low Energy, NFC or other mechanism to transfer information between the devices.

The mobile device may be equipped with global positioning information such as GPS, which may indicate to the mobile device its location. By capturing the information from the sensor station and knowing the mobile device's location, data transfer operations are facilitated and validated using the host system. Moreover, a sensor station may include GPS to verify its own location or be supplied with location information defining an allowable range for interactions with a mobile device. This provides for defining a geographical limit by comparing the mobile device geo-location with the sensor stations allowable geo-locations. Certain embodiments may allow for communications between differing mobile devices facilitated by the host system to effectuate payment through mobile devices that are not present at the facility or close to the sensor station.

Once the mobile device captures the sensor station identifier, the mobile device may communicate that information to a host system to validate the sensor station is active and associated with a particular location.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed:

1. A reporting method including:
receiving over a network target authority information, said target authority information including at least a target image, and a contact information;
storing said target authority information on a server in a structured data store;
receiving at the server, a media information, said media information including at least a location information and a location image, said location image associated with the location information;
comparing the location image with the target image to identify at least one difference between the location image and the target image, and
transmitting to the contact information the location information and the location image and the difference in response to said comparing,
wherein the transmitting is only effectuated if the difference crosses a predetermined threshold.

2. The method of claim 1 wherein the image of the target is a point-of-sale display and the predetermined threshold is a stocking level of inventory.

3. The method of claim 1 wherein the image of the target is a rest room and the difference is cleanliness.

4. The method of claim 1 wherein the image of the target is a product plan-o-gram and the predetermined threshold is a product placement.

5. A reporting method including:
receiving, at a server, target authority information, said target authority information including identifying information and contact information related to a target,
receiving, at the server, a reporting information, said reporting information including location information and a media information,
analyzing the media information to identify a target information,
comparing the target information to the target authority information, and
transmitting the target information to the target authority using the contact information.

6. The method of claim 5 wherein the media information is at least one of an image, a video, or an audio recording.

7. The method of claim 5 wherein the analyzing is effectuated by transmitting the media information to a second server and receiving an identity information in response.

8. The method of claim 7 wherein the analyzing is further effectuated using an application programming interface on the second server.

9. The method of claim 5 wherein the identifying information is an image of the target and the media information is an image of a facility location.

10. The method of claim 9 wherein said comparing includes comparing the image of the target with the media information to determine one or more differences between the image of the target and the media information.

11. The method of claim 10 further including:
comparing the one or more differences to at least a threshold value and
transmitting an indication that the threshold value was exceeded.
